(19) United States
(12) Patent Application Publication
(10) Pub. No.: US 2009/0167774 A1
(43) Pub. Date: Jul. 2, 2009

(54) DEVICE, SYSTEM, AND METHOD OF USER-INTERFACE RENDERING

(76) Inventors: Roy Want, Los Altos, CA (US); Trevor Pering, San Francisco, CA (US)

Correspondence Address: Shiloh et al., C/O INTELLEVATE , LLC, P.O BOX 52050, MINNEAPOLIS, MN, 55402, US

(21) Appl. No.: 11/967,291

(22) Filed: Dec. 31, 2007

(51) Int. Cl. G06F 12/02; G09G 5/36

(52) U.S. Cl. 345/543; 345/545; 345/1.1

(57) ABSTRACT

Device, system, and method of user-interface rendering. In some demonstrative embodiments, a mobile device may include a display having a first display area; a first user-interface application to render a first user-interface on the display; a second user-interface application to render a second user-interface adapted to be displayed on a second display having a display area larger than the first display area; a frame buffer allocated to buffer information of the first user-interface application; a second frame buffer allocated to buffer information of the second user-interface application; a wireless communication module to communicate with an external display over a wireless communication link; and a remote-frame-buffer protocol to transfer the information of the second user-interface from the second frame buffer to the second display via a wireless communication link. Other embodiments are described and claimed.

### BACKGROUND

A mobile device may include a display having a relatively small display area, e.g., an inch-sized display area, compared, for example, to a display of a personal computer or a notebook computer.

### BRIEF DESCRIPTION OF THE DRAWINGS

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. The figures are listed below.

FIG. 1 is a schematic block diagram illustration of a system in accordance with some demonstrative embodiments; and

FIG. 2 is a schematic flow-chart illustration of a method of user-interface rendering in accordance with some demonstrative embodiments.

### DETAILED DESCRIPTION

In the following detailed description, numerous specific details are set forth in order to provide a thorough understanding of some embodiments. However, it will be understood by persons of ordinary skill in the art that some embodiments may be practiced without these specific details. In other instances, well-known methods, procedures, components, units and/or circuits have not been described in detail so as not to obscure the discussion.

Discussions herein utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

The terms “plurality” and “a plurality” as used herein include, for example, “multiple” or “two or more”. For example, “a plurality of items” includes two or more items.

Although portions of the discussion herein relate, for demonstrative purposes, to wired links and/or wired communications, embodiments of the invention are not limited in this regard, and may include one or more wired or wireless links, may utilize one or more components of wireless communication, may utilize one or more methods or protocols of wireless communication, or the like. Some embodiments may utilize wired communication and/or wireless communication.

Some embodiments may be used in conjunction with various devices and systems, for example, a Personal Computer (PC), a desktop computer, a mobile computer, a laptop computer, a notebook computer, a tablet computer, a server computer, a handheld computer, a handheld device, a Personal Digital Assistant (PDA) device, a handheld PDA device, an on-board device, an off-board device, a hybrid device, a vehicular device, a non-vehicular device, a mobile or portable device, a non-mobile or non-portable device, a wireless communication station, a wireless communication device, a wireless Access Point (AP), a wired or wireless router, a wired or wireless modem, a wired or wireless network, a Local Area Network (LAN), a Wireless LAN (WLAN), a Metropolitan Area Network (MAN), a Wireless MAN (WMAN), a Wide Area Network (WAN), a Wireless WAN (WWAN), a Personal Area Network (PAN), a Wireless PAN (WPAN), devices and/or networks operating in accordance with existing IEEE 802.11, 802.11a, 802.11b, 802.11g, 802.11n, 802.16, 802.16d, 802.16e, 802.20, 802.21 standards and/or future versions and/or derivatives of the above standards, units and/or devices which are part of the above networks, one way and/or two-way radio communication systems, cellular radio-telephone communication systems, a cellular telephone, a wireless telephone, a Personal Communication Systems (PCS) device, a PDA device which incorporates a wireless communication device, a mobile or portable Global Positioning System (GPS) device, a device which incorporates a GPS receiver or transceiver or chip, a device which incorporates an RFID element or chip, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, Digital Video Broadcast (DVB) devices or systems, multi-standard radio devices or systems, a wired or wireless handheld device (e.g., BlackBerry, Palm Treo), a Wireless Application Protocol (WAP) device, or the like.

Some embodiments may be used in conjunction with one or more types of wireless communication signals and/or systems, for example, Radio Frequency (RF), Infra Red (IR), Frequency-Division Multiplexing (FDM), Orthogonal FDM (OFDM), Time-Division Multiplexing (TDM), Time-Division Multiple Access (TDMA), Extended TDMA (E-TDMA), General Packet Radio Service (GPRS), extended GPRS, Code-Division Multiple Access (CDMA), Wideband CDMA (WCDMA), CDMA 2000, single-carrier CDMA, multi-carrier CDMA, Multi-Carrier Modulation (MDM), Discrete Multi-Tone (DMT), Bluetooth (®), Global Positioning System (GPS), Wi-Fi, Wi-Max, ZigBee (™), Ultra-Wideband (UWB), Global System for Mobile communication (GSM), 2 G, 2.5 G, 3 G, 3.5 G, Enhanced Data rates for GSM Evolution (EDGE), or the like. Other embodiments may be used in various other devices, systems and/or networks.

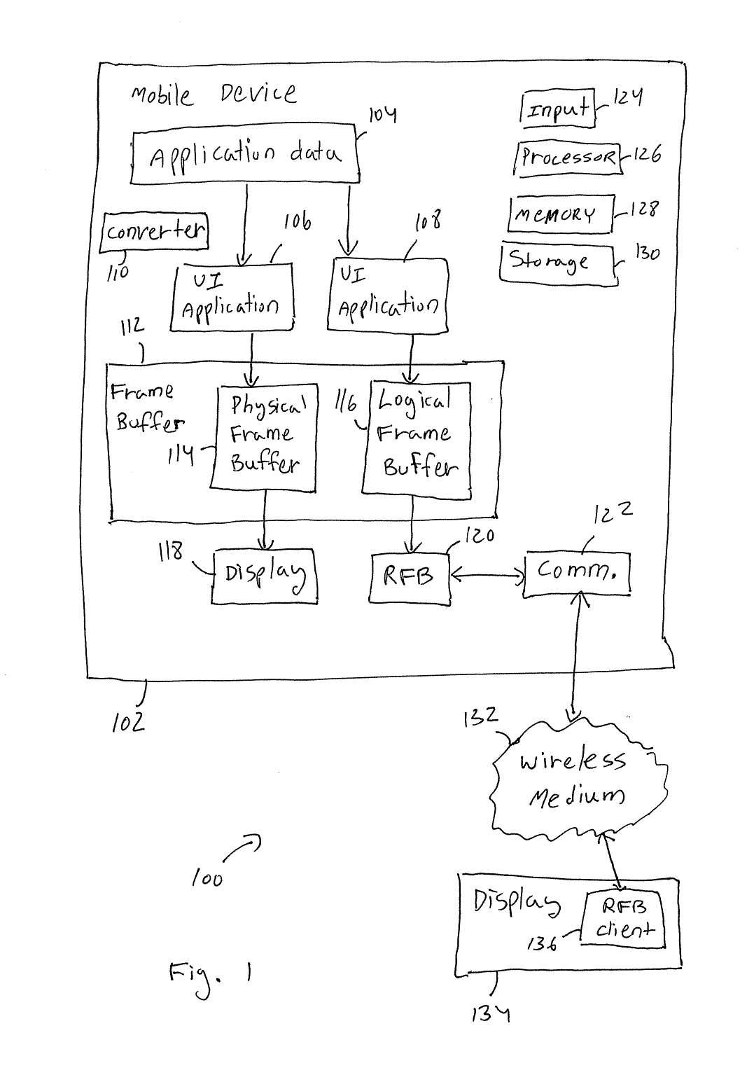

Reference is made to FIG. 1, which schematically illustrates a block diagram of a system 100 in accordance with some demonstrative embodiments.

System 100 includes, for example, a mobile device 102 and an external display 134, e.g., located externally to mobile device 102. Mobile device and display 134 may communicate using, for example, a wireless communication medium 132. Wireless communication medium 132 may include any suitable wireless communication link and/or connection, for example, a local wireless-connection, e.g., an IEEE 802.11 communication link, an IEEE 802.16 communication link, a Bluetooth communication link, an UWB communication link, or the like. I

Mobile device 102 includes, for example, a laptop computer, a notebook computer, a tablet computer, a PDA device, a cellular phone, a mobile phone, a hybrid device, e.g., combining cellular phone functionalities with PDA device functionalities, a relatively small computing device, a “smart-phone”, a non-desktop computer, a portable device, a handheld device, a “Carry Small Live Large” (CSLL) device, an Ultra Mobile Device (UMD), an Ultra Mobile PC (UMPC), a Mobile Internet Device (MID), an “Origami” device or computing device, a device that supports Dynamically Composable Computing (DCC), a context-aware device, or the like.

Mobile device 102 includes, for example, a processor 126; an internal memory 128, e.g., a Random Access Memory (RAM); an internal storage 130, e.g., a hard disk drive; an integrated input unit 124, e.g., a keyboard and/or a touch-pad integrated within a housing or body of mobile device 102; a wireless communication module 122, e.g., including e.g., one or more transceivers and/or antennas, capable of communicating with display 134 over wireless medium 132, and an integrated display 118, e.g., a screen integrated within the housing or body of mobile device 102. In some demonstrative embodiments, communication module 122 may include a short range high-bandwidth communication module, e.g., a UWB communication module. In other embodiments, communication module 122 may include any other suitable wireless communication module.

In some demonstrative embodiments, mobile device 102 may also include a first user-interface (UI) application 106 to render a first user-interface on display 118, and a second UI application 108 to render a second user-interface adapted to be displayed on an external display, e.g., display 134, having a display area larger than the display area of display 118, e.g., as described below.

In some demonstrative embodiments, UI application 106 may include any suitable application to render a UI adapted to the display area, resolution, graphic configuration, font size, icon size, and/or any other suitable parameter of display 118. For example, UI application may include the Qtopia application, the WinMobile application, and the like. UI application 108 may include any suitable application to render a UI adapted to the display area, resolution, graphic configuration, font size, icon size, and/or any other suitable parameter of display 134. For example, UI application may include any suitable PC-adapted application, for example, a PC enterprise application, the Windows application, the PowerPoint application, the Excel application, and the like.

In some demonstrative embodiments, the second UI rendered by UI application 108 may include one or more graphical components, which are may not be included in the first UI rendered by UI application 106. The graphical components may include, for example, one or more icons, menus, task bars, tool bars, and the like.

In some embodiments, display 118 may have a first display area, which may be smaller than a second display area of display 134. For example, the display area of display 134 may be at least three times, for example, at least ten times, e.g., at least twenty-five times, larger than the display area of display 118. In one example, display 118 may include a pocket-sized and/or inch-sized display, e.g., having a display area with a length and/or height of less than five inches, e.g., less than three inches. Display 134 may be capable of providing, for example, necessary resolution and/or display area required by PC-adapted applications. In one example, display 134 may include a PC-sized display, e.g., having a display area with a length and/or height of at least ten inches.

In some demonstrative embodiments, UI application 106 and/or UI application 108 may be implemented by any suitable one or more elements or components of mobile device 102. For example, memory 128 and/or storage 130 may store a first set of UI instructions, which when executed by processor 126 may result in UI interface 106; and/or a second set of UI instructions, which when executed by processor 126 may result in UI interface 108.

In some demonstrative embodiments, mobile device 102 may also include a frame buffer 112 having a first area 114 (“the physical frame buffer”) allocated to buffer information for UI application 106, and a second area 116 (“the logical frame buffer’) allocated to buffer information for UI application 108. For example, UI application 106 may render into frame buffer 114 display data of the first UI, and UI application 108 may render into frame buffer 116 display data of the second UI, e.g., as if a display of mobile device 102 is capable of rendering the second UI and/or without being aware whether or not mobile device includes such a display.

In some demonstrative embodiments, frame buffer 112 may be implemented as part of any suitable element of mobile device 102. In one example, at least part of frame buffer 112 may be implemented as a “real” or “physical” frame buffer memory, e.g., as part of memory 128. In another example, at least part of frame buffer 112 may be implemented as a “logical” or “virtual” frame buffer, which may include, for example, state information, e.g., size, and/or window location, representing a display.

In some demonstrative embodiments, mobile device 102 may also include a Remote-Frame-Buffer (RFB) protocol to transfer the second user-interface to display 134, e.g., via medium 132.

In some demonstrative embodiments, RFB protocol 120 may be capable of providing to display 134 a substantially exact replica of the second UI, which is rendered by UI application 108 to logical frame buffer 116. RFB protocol 120 may include any suitable application, program and/or protocol. For example, RFB protocol 120 may include a Virtual Network Computing (VNC) application.

In some demonstrative embodiments, RFB protocol 120 may include a RFB server protocol, e.g., a VNC server protocol, capable of monitoring logical frame buffer 116 to detect a change in the buffered information for UI application 108; and, upon detecting a change in the buffered information, to transfer the buffered information, e.g., in a compressed format, to display 134, e.g., via wireless medium 132. Display 134 may include a RFB client protocol, e.g., a suitable VNC client protocol, capable of updating an image displayed by display 134, e.g., based on the buffered information received from RFB protocol 120.

In some demonstrative embodiments, mobile device 102 may provide a user with a considerably enhanced user experience in terms of display capabilities, since mobile device 102 may utilize display 134 to provide the user with a full PC experience.

In some demonstrative embodiments, mobile device may store application data 104 on any suitable memory and/or storage element or unit, e.g., memory 128 and/or storage 130.

In some demonstrative embodiments, both UI application 106 and UI application 108 may render the first and second user-interfaces, respectively, based on at least part of application data 104.

In some demonstrative embodiments, application data 104 may include a data format suitable for both UI application 106 and UI application 108. In one example, application data 104 may include a set of graphical components, e.g., icons, menus and the like. UI application 106 may include a smart-phone “contact-list” application capable of rendering a first subset of the set of graphical components, and UI application 108 may include a PC “contact-list” application capable of rendering a second subset of the set of graphical components.

In some demonstrative embodiments, application data 104 may include a data format suitable for only one UI application 106 and UI application 108 (“the compatible UI application”), and not suitable for another of UI application 106 and UI application 108 (“the non-compatible UI application”). According to these embodiments, mobile device may include a converter to convert application data 104 into a format suitable for the non-compatible UI application. In one example, application data 104 may include one or more data formats suitable only for UI application 104, and converter 110 may include an application or software shim to convert the data format of application data into a data format suitable for UI application 108.

In some demonstrative embodiments, a user may utilize mobile device 102 as a full PC system, for example, without the burden of carrying around a PC, e.g., a notebook computer, having a large display, a keyboard, and the like. In one example, the user may drop use mobile device 102 to render the first UI application on display 118, e.g., when traveling and/or when the user may not have access to display 134. However, when the user is near display 134, the user may utilize computing resources of mobile device 102, e.g., computing resources of processor 126 and/or memory 128, to have the full PC experience, for example, by reliably accessing data and/or applications stored on mobile device 102. Furthermore, there may be substantially no wireless service fees, roaming fees, and/or or over data-limit fees, that would have to be paid by a user, e.g., if wireless medium a local wireless-connection.

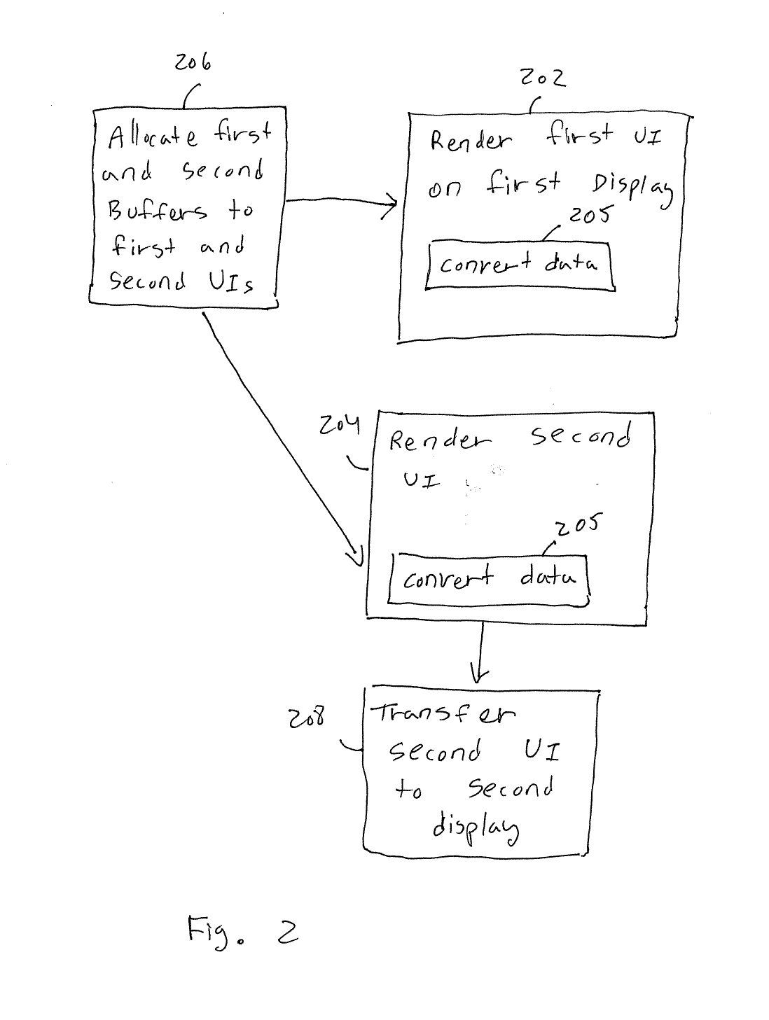

Reference is now made to FIG. 2, which schematically illustrates a method of UI rendering, in accordance with some demonstrative embodiments. In some non-limiting embodiments, one or more operations of FIG. 2 may be performed by a mobile device, e.g., mobile device 102 (FIG. 1), to render a first UI on a first display, e.g., display 118 (FIG. 1), and a second UI on a second display, e.g., display 134 (FIG. 1).

As indicated at block 202, the method may include rendering a first UI on a display of a mobile device having a first display area. For example, UI application 106 (FIG. 1) may render the first UI on display 118 (FIG. 1), e.g., as described above.

As indicated at block 204, the method may also include rendering a second UI adapted to be displayed on a second display area larger than the first display area. For example, UI application 108 (FIG. 1) may render the second UI on display 134 (FIG. 1), e.g., as described above.

In some demonstrative embodiments, the first and second user-interfaces may be rendered by first and second UI applications, e.g., as described above.

In some demonstrative embodiments, rendering the first and second user-interfaces may include rendering both the first and second user-interfaces based on common application data, e.g., as described above.

In some demonstrative embodiments, the application data may include a data format suitable for both the first and second user-interface applications, e.g., as described above.

In some demonstrative embodiments, the application data may include a data format suitable for one of the first and second user-interface applications, and the method may include converting the application data into a format suitable for another one of the first and second user-interface applications, as indicated at block 205.

As indicated at block 206, the method may include allocating a first area of a frame buffer to buffer information corresponding to the first UI, and a second area of the frame buffer to buffer information corresponding to the second UI. For example, mobile device 102 (FIG. 1) may allocate physical frame buffer 114 (FIG. 1) to buffer information for UI application 106 (FIG. 1), and logical frame buffer 116 (FIG. 1) to buffer information for UI application 108 (FIG. 1), e.g., as described above.

As indicated at block 208, the method may also include transferring the second UI to an external display via a wireless communication link. For example, RFB protocol 120 (FIG. 1) may transfer the second UI to display 134 (FIG. 1) over wireless medium 132 (FIG. 1), e.g., as described above.

Other operations or sets of operations may be used in accordance with some embodiments.

Some embodiments, for example, may take the form of an entirely hardware embodiment, an entirely software embodiment, or an embodiment including both hardware and software elements. Some embodiments may be implemented in software, which includes but is not limited to firmware, resident software, microcode, or the like.

Furthermore, some embodiments may take the form of a computer program product accessible from a computer-usable or computer-readable medium providing program code for use by or in connection with a computer or any instruction execution system. For example, a computer-usable or computer-readable medium may be or may include any apparatus that can contain, store, communicate, propagate, or transport the program for use by or in connection with the instruction execution system, apparatus, or device.

In some embodiments, the medium may be an electronic, magnetic, optical, electromagnetic, infrared, or semiconductor system (or apparatus or device) or a propagation medium. Some demonstrative examples of a computer-readable medium may include a semiconductor or solid state memory, magnetic tape, a removable computer diskette, a random access memory (RAM), a read-only memory (ROM), a rigid magnetic disk, and/or an optical disk. Some demonstrative examples of optical disks include compact disk-read only memory (CD-ROM), compact disk-read/write (CD-R/W), and DVD.

In some embodiments, a data processing system suitable for storing and/or executing program code may include at least one processor coupled directly or indirectly to memory elements, for example, through a system bus. The memory elements may include, for example, local memory employed during actual execution of the program code, bulk storage, and cache memories which may provide temporary storage of at least some program code in order to reduce the number of times code must be retrieved from bulk storage during execution.

In some embodiments, input/output or I/O devices (including but not limited to keyboards, displays, pointing devices, etc.) may be coupled to the system either directly or through intervening I/O controllers. In some embodiments, network adapters may be coupled to the system to enable the data processing system to become coupled to other data processing systems or remote printers or storage devices, for example, through intervening private or public networks. In some embodiments, modems, cable modems and Ethernet cards are demonstrative examples of types of network adapters. Other suitable components may be used.

Functions, operations, components and/or features described herein with reference to one or more embodiments, may be combined with, or may be utilized in combination with, one or more other functions, operations, components and/or features described herein with reference to one or more other embodiments, or vice versa.

While certain features have been illustrated and described herein, many modifications, substitutions, changes, and equivalents may occur to those skilled in the art. It is, therefore, to be understood that the appended claims are intended to cover all such modifications and changes as fall within the true spirit of the invention.

What is claimed is:

1. A mobile device comprising:
a display having a first display area;
a first user-interface application to render a first user-interface on said display;
a second user-interface application to render a second user-interface adapted to be displayed on a second display having a display area larger than said first display area;
a frame buffer allocated to buffer information of said first user-interface application;
a second frame buffer allocated to buffer information of said second user-interface application;
a wireless communication module to communicate with an external display over a wireless communication link; and
a remote-frame-buffer protocol to transfer the information of said second user-interface from said second frame buffer to said second display via a wireless communication link.

2. The mobile device of claim 1 comprising a memory to store application data, and wherein both said first and second user-interface applications render said first and second user-interfaces, respectively, based on at least part of said application data.

3. The mobile device of claim 2, wherein said application data comprises a data format suitable for both said first and second user-interface applications.

4. The mobile device of claim 2, wherein said application data comprises a data format suitable for one of said first and second user-interface applications, and wherein said mobile device comprises a converter to convert said application data into a format suitable for another one of said first and second user-interface applications.

5. The mobile device of claim 1, wherein said second user-interface includes one or more graphical components, which are not included in said first user-interface.

6. The mobile device of claim 1, wherein the display area of said second display is at least three times larger than said first display area.

7. The mobile device of claim 1, wherein said wireless communication link comprises a local wireless communication link.

8. The mobile device of claim 1, wherein said mobile device comprises a device selected from the group consisting of: a cellular phone, a handheld device, a wireless communication device, and a personal-digital-assistant device, a smart phone, and ultra-mobile-device.

9. A method comprising:
rendering a first user-interface on a display of a mobile device having a first display area;
rendering a second user-interface adapted to be displayed on a second display having a display area larger than the first display area;
allocating a first frame buffer to buffer information corresponding to said first user-interface, and a second frame buffer to buffer information corresponding to said second user-interface; and
transferring the information corresponding to said second user-interface to said second display via a wireless communication link.

10. The method of claim 9 comprising rendering both said first and second user-interfaces based on common application data.

11. The method of claim 10, wherein said application data comprises a data format suitable for both said first and second user-interface applications.

12. The method of claim 10, wherein said application data comprises a data format suitable for one of said first and second user-interface applications, and wherein said method comprises converting said application data into a format suitable for another one of said first and second user-interface applications.

13. The method of claim 9, wherein said second user-interface includes one or more graphical components, which are not included in said first user-interface.

14. The method of claim 9, wherein the display area of said second display is at least three times larger than said first display area.

15. The method of claim 9, wherein said wireless communication link comprises a local wireless communication link.
